(19) United States
(12) Patent Application Publication
(10) Pub. No.: US 2025/0017697 A1
(43) Pub. Date: Jan. 16, 2025

(54) Dental Bracket with Removable Bracket Covers

(71) Applicant: Clearbrace LLC, Chelmsford, MA (US)

(72) Inventors: Amitabha Lala, Andover, MA (US); Subhrangshu Datta, Arlington, MA (US)

(21) Appl. No.: 18/781,683

(22) Filed: Jul. 23, 2024

Related U.S. Application Data
(63) Continuation-in-part of application No. 17/777,267, filed on May 16, 2022.
(60) Provisional application No. 62/937,693, filed on Nov. 19, 2019.

(51) Int. Cl. A61C 7/14; A61C 7/28

(52) U.S. Cl. CPC A61C 7/141; A61C 7/287

(57) ABSTRACT

A dental bracket can be used to generate a force profile corresponding to a target tooth movement (e.g., for moving and aligning the teeth of an orthodontic patient). The dental bracket includes a base and a cover. The base is configured to be attached to an anterior surface of a tooth, and the cover is removably attached to the base. The cover includes a slot configured to receive a wire. In some implementations, at least one of the size, shape, or orientation of the slot corresponds to a force profile corresponding to a target tooth movement. Example target tooth movements include a mesial root movement, a distal root movement, a mesial crown movement, a distal crown movement, an intrusion movement, an extrusion movement, a mesial crown rotation, a distal crown rotation, a buccal root movement, or a lingual root movement.

### CROSS-REFERENCE TO RELATED APPLICATIONS

This application is a continuation in part of U.S. patent application Ser. No. 17/777,267, filed on May 16, 2022, which is a National Stage Application under 35 USC § 371 and claims the benefit of International Patent Application No. PCT/US2020/061227, filed on Nov. 19, 2020, which claims the benefit of U.S. Provisional Patent Application No. 62/937,693, filed on Nov. 19, 2019, which are incorporated herein by reference in their entirety.

### BACKGROUND

This description relates to a novel system of dental braces. Dental braces are devices used in orthodontics to move and align the teeth of a patient. Dental brace systems typically include multiple dental brackets attached to the teeth of a patient and a wire connecting the multiple dental brackets. Traditional dental brackets may have slots and notches to interface with the wire. Moreover, auxiliary items such as elastic bands may be required for holding the wire to the brackets and for accomplishing certain tooth movements.

### SUMMARY

This document describes technology for generating a force profile corresponding to a target tooth movement (e.g., for moving and aligning the teeth of an orthodontic patient).

In general, in an aspect, a dental bracket includes a base and a cover. The base is configured to be attached to an anterior surface of a tooth, and the cover is removably attached to the base. The cover (sometimes referred to as an insert) further includes a slot configured to receive a wire.

Implementations may include one or a combination of two or more of the following features. The base may include one or more of a first mating structure configured to receive a reciprocal second mating structure. The cover may include one or more of the second mating structures, and the cover may be removably connected to the base via a coupling between the one or more first mating structures and the corresponding one or more second mating structures. At least one of the size, shape, or orientation of the slot may correspond to a force profile corresponding to a target tooth movement. For example, the target tooth movement may include a mesial root movement, a distal root movement, a mesial crown movement, a distal crown movement, an intrusion movement, an extrusion movement, a mesial crown rotation, a distal crown rotation, a buccal root movement, or a lingual root movement. In some cases, the slot may be longitudinally enclosed within the cover and include a first cross-section opening on a mesial aspect of the cover and a second cross-section opening on a distal aspect of the cover. In some cases, the slot may include a first cross-section opening on a mesial aspect of the cover, a second cross-section opening on a distal aspect of the cover, and a longitudinal opening on a posterior aspect of the cover. In such cases, the slot may be configured to be longitudinally enclosed upon connecting the cover of the dental bracket to the anterior surface of the base. The cover may comprise one or more cosmetic elements on its anterior surface including at least one of a color, a design, a jewel, a logo, a symbol, etc.

In general, in an aspect, a method for generating a force profile corresponding to a target tooth movement includes attaching a base of a dental bracket to an anterior surface of a tooth. The method further includes selecting, from multiple candidate covers, a cover of the dental bracket for coupling to the base. The cover is selected in accordance with the force profile corresponding to the target tooth movement. Each of the multiple candidate covers includes a slot configured to receive a wire. The method further includes inserting a wire through the slot of the selected cover and attaching the selected cover to the base in a removable configuration to generate the force profile on the tooth.

Implementations may include one or a combination of two or more of the following features. Attaching the selected cover of the dental bracket to the anterior surface of the base may include coupling one or more of a first mating structure of the base with corresponding one or more second mating structures of the cover. The method may further include locking the wire into position relative to the dental bracket such that the wire has a singular degree of freedom comprising sliding through the slot. Locking the wire into position relative to the dental bracket may include applying force to the cover in a first direction, the first direction being different from a direction of force required to connect the cover of the dental bracket to the base. At least one of the size, shape, or orientation of the slot may correspond to the force profile corresponding to the target tooth movement. For example, the target tooth movement may include a mesial root movement, a distal root movement, a mesial crown movement, a distal crown movement, an intrusion movement, an extrusion movement, a mesial crown rotation, a distal crown rotation, a buccal root movement, or a lingual root movement. In some cases, the slot may be longitudinally enclosed within the cover and include a first cross-section opening on a mesial aspect of the cover and a second cross-section opening on a distal aspect of the cover. In some cases, the slot may include a first cross-section opening on a mesial aspect of the cover, a second cross-section opening on a distal aspect of the cover, and a longitudinal opening on a posterior aspect of the cover. In such cases, the slot may be configured to be longitudinally enclosed upon connecting the cover of the dental bracket to the anterior surface of the base. The method may also include periodically replacing the cover of the dental bracket with a replacement cover, the replacement cover having a modified slot that differs in size, shape, or orientation, from the slot of the replaced cover.

In general, in an aspect, a dental brace system includes one or more dental brackets and a wire. Each dental bracket includes a base and a cover, the base configured to be attached to an anterior surface of a tooth, and the cover removably attached to the base. The cover of each dental bracket further includes a slot, and the wire extends through the slot of each dental bracket.

Implementations may include one or a combination of two or more of the following features. The base may include one or more of a first mating structure configured to receive a reciprocal second mating structure. The cover may include one or more of the second mating structures, and the cover may be removably connected to the base via a coupling between the one or more first mating structures and the corresponding one or more second mating structures. At least one of the size, shape, or orientation of the slot may correspond to a force profile corresponding to a target tooth movement. For example, the target tooth movement may include a mesial root movement, a distal root movement, a mesial crown movement, a distal crown movement, an intrusion movement, an extrusion movement, a mesial crown rotation, a distal crown rotation, a buccal root movement, or a lingual root movement. In some cases, the slot may be longitudinally enclosed within the cover and include a first cross-section opening on a mesial aspect of the cover and a second cross-section opening on a distal aspect of the cover. In some cases, the slot may include a first cross-section opening on a mesial aspect of the cover, a second cross-section opening on a distal aspect of the cover, and a longitudinal opening on a posterior aspect of the cover. In such cases, the slot may be configured to be longitudinally enclosed upon connecting the cover of the dental bracket to the anterior surface of the base. The cover may comprises one or more cosmetic elements on its anterior surface including at least one of a color, a design, a jewel, a logo, a symbol, etc.

In general, in an aspect, a method for changing a first cover of a dental bracket includes detaching the first cover from a base of the dental bracket, the base attached to an anterior surface of a tooth. The method further includes selecting, from multiple candidate covers, a second cover of the dental bracket for coupling to the base. Each of the multiple candidate covers includes a slot configured to receive a wire, the orientation of the slot being in accordance with a force profile corresponding to a target tooth movement. The method further includes inserting a wire through the slot of the second cover and attaching the second cover to the base in a removable configuration to generate the force profile on the tooth.

Implementations may include one or a combination of two or more of the following features. Detaching the first cover of the dental bracket from the anterior surface of the base may include decoupling one or more of a first mating structure of the base with corresponding one or more second mating structures of the first cover. Attaching the second cover of the dental bracket to the anterior surface of the base may include coupling one or more of a first mating structure of the base with corresponding one or more second mating structures of the second cover. The method may further include locking the wire into position relative to the dental bracket such that the wire has a singular degree of freedom comprising sliding through the slot. Locking the wire into position relative to the dental bracket may include applying force to the second cover in a first direction, the first direction being different from a direction of force required to connect the second cover of the dental bracket to the base. At least one of the size, shape, or orientation of the slot may correspond to the force profile corresponding to the target tooth movement. For example, the target tooth movement may include a mesial root movement, a distal root movement, a mesial crown movement, a distal crown movement, an intrusion movement, an extrusion movement, a mesial crown rotation, a distal crown rotation, a buccal root movement, or a lingual root movement. In some cases, the slot may be longitudinally enclosed within the second cover and include a first cross-section opening on a mesial aspect of the second cover and a second cross-section opening on a distal aspect of the second cover. In some cases, the slot may include a first cross-section opening on a mesial aspect of the second cover, a second cross-section opening on a distal aspect of the second cover, and a longitudinal opening on a posterior aspect of the second cover. In such cases, the slot may be configured to be longitudinally enclosed upon connecting the second cover of the dental bracket to the anterior surface of the base. The second cover may have a modified slot that differs in size, shape, or orientation, from a slot of the first cover. The second cover may include one or more cosmetic elements on its anterior surface that differ from one or more cosmetic elements on the anterior surface of the first cover. In some cases, the method may further include, prior to inserting the wire through the slot of the second cover, removing the wire from a slot of the first cover. In some cases, the wire inserted through the slot of the second cover is a replacement wire distinct from a wire extending through a slot of the first cover.

In some implementations, the technology described herein may exhibit one or more of the following advantages. A dental brace system having dental brackets with removable bracket covers may enable easier operation and improved adjustments, for example, by obviating the need to replace brackets that are affixed to teeth. For example, replacing removably-coupled bracket covers having appropriate wire slots can take far less time than replacing traditional brackets that are attached to teeth with adhesive compounds on a semi-permanent basis. This in turn saves time for both patients and clinicians, e.g., by reducing time required to adjust a force profile on a set of teeth. Different bracket covers may be configured to generate different force profiles corresponding to various target tooth movements, based on, for example, shape, size, and/or orientation of a wire slot or channel disposed in the bracket cover. Moreover, the removable bracket covers can have connection mechanisms for secure attachment to, and easy removal from, a base of the dental bracket, enabling easy replacement of the bracket covers. In some implementations, the dental brackets may have a low-profile, and a smooth external surface that is less irritating to the lips and inside cheek of a patient, easier for the patient to clean, and less likely to be damaged (e.g., from getting caught on food). The dental brackets described herein may also be more aesthetically pleasing than traditional dental brackets and may be customized with cosmetic elements to the patient's liking. In some cases, a dental brace system including the dental brackets described herein may reduce the overall duration of treatment compared to existing dental brace systems.

These and other aspects, features, and various combinations may be expressed as apparatuses, systems, methods, means for performing functions, etc.

Other features and advantages will be apparent from the description and the claims.

### BRIEF DESCRIPTION OF DRAWINGS

FIG. 1 is a front view of a dental brace system.

FIG. 2A is a front view of a base of a dental bracket attached to a tooth, in accordance with an example implementation of the technology described herein.

FIG. 2B is a side view of the example of the base of the dental bracket of FIG. 2A.

FIG. 3A is a front view of a cover of a dental bracket, in accordance with an example implementation of the technology described herein.

FIG. 3B is a top view of a cover of a dental bracket, in accordance with an example implementation of the technology described herein.

FIG. 3C is a side view of a cover of a dental bracket, in accordance with an example implementation of the technology described herein.

FIG. 4A is a side view of a dental bracket system including the base of FIGS. 2A-2B, and the cover of FIGS. 3A-3C, in a separated state.

FIG. 4B is a side view of the dental bracket system of FIG. 4A in an attached but unlocked state, in accordance with an example implementation of the technology described herein.

FIG. 4C is a side view of the dental bracket system of FIG. 4A in a locked state, in accordance with an example implementation of the technology described herein.

FIG. 5 is a side view of a second example embodiment of a dental bracket system in a locked state.

FIG. 6A is a top view of a third example embodiment of a dental bracket system in a locked state.

FIG. 6B is a side view of the dental bracket system of FIG. 6A in a locked state.

FIG. 7A is a side view of a fourth example embodiment of a dental bracket system in a separated state.

FIG. 7B is a side view of the dental bracket system of FIG. 7A in a locked state.

FIG. 8A is a posterior view of a base of a dental bracket, in accordance with a fifth example embodiment of a dental bracket system.

FIG. 8B is a top view of a base of a dental bracket, in accordance with a fifth example embodiment of a dental bracket system.

FIG. 8C is a side view of a base of a dental bracket, in accordance with a fifth example embodiment of a dental bracket system.

FIG. 8D is an isometric view of a base of a dental bracket, in accordance with a fifth example embodiment of a dental bracket system.

FIG. 9A is an anterior view of a cover of a dental bracket, in accordance with a fifth example embodiment of a dental bracket system.

FIG. 9B is a top view of a cover of a dental bracket, in accordance with a fifth example embodiment of a dental bracket system.

FIG. 9C is a side view of a cover of a dental bracket, in accordance with a fifth example embodiment of a dental bracket system.

FIG. 9D is an isometric view of a cover of a dental bracket, in accordance with a fifth example embodiment of a dental bracket system.

FIGS. 10A-10I are examples of covers of dental brackets configured to generate various force profiles corresponding to various target tooth movements.

FIG. 11 is a flow chart of a process for generating a force profile corresponding to a target tooth movement.

FIG. 12 is a flow chart of a process for changing a first cover of a dental bracket.

### DETAILED DESCRIPTION

In the field of orthodontics, dental brace systems are often used for moving a patient's teeth (e.g., straightening and aligning teeth). Dental brace systems typically work by generating and applying a force profile to one or more teeth of the patient, the force profile corresponding to a target tooth movement. Examples of target tooth movements include a mesial root movement, a distal root movement, a mesial crown movement, a distal crown movement, an intrusion movement, an extrusion movement, a mesial crown rotation, a distal crown rotation, a buccal root movement, or a lingual root movement.

Traditional dental brace systems typically include one or more dental brackets attached to the teeth of a patient and a wire (e.g., an arch wire) connecting the multiple dental brackets to generate a force distribution on the teeth. The dental brackets may have slots and notches to interface with the wire, and in some cases, auxiliary items such as elastic bands may be required for holding the wire to the brackets and for accomplishing certain tooth movements. Consequently, in some cases, traditional dental brace systems may be uncomfortable for the patient, hard to clean, difficult to operate, expensive, and/or aesthetically displeasing.

Here, we describe, among other things, a dental brace system having dental brackets with removable covers. In some implementations, the two-part dental brackets described herein can address one or more drawbacks of the traditional dental brace systems. For example, the technology described herein can significantly improve the treatment process and/or time by facilitating easy adaptation of the dental brackets to the changing requirements of force distribution on the teeth of a patient during the course of treatment. A first force distribution required at the beginning of treatment (e.g., a torque required to rotate a tooth) can be significantly different from a second force distribution (e.g., a reduced torque) that is required after a few weeks, once the tooth has rotated to some extent from the initial position. When a traditional brace system is being used, individual brackets, which are attached to the teeth using strong adhesives, may have to be removed and replaced to produce the second, different force distribution. Because of the semi-permanent nature of the attachment of the brackets to the teeth, this can be time-consuming and/or uncomfortable for the patient. The two-part bracket described herein includes a bracket cover that can be securely but removably attached to a bracket base that is semi-permanently attached to the tooth. The cover, and not the base, includes a channel/slot for receiving the wire that generates the desired force distribution. Therefore, when the desired force distribution changes, the bracket cover can be removed and replaced easily without having to remove the base that is attached to the tooth. This in turn can result in significant savings in the treatment time, not just by making the bracket replacement expeditious, but also by improving the treatment itself by making it more frequently adaptive. In addition, a large number of options for producing different force distributions can be made available by providing covers with appropriate orientations of the wire-slot, thereby providing significantly improved flexibility for the clinicians. The wire-slot or channel can be disposed in the bracket cover such that the wire running through the slot/channel is occluded by the external surface of the cover, thereby potentially improving the aesthetics of the bracket system. In some cases, the bracket cover can even be made customizable (e.g., with respect to colors, logos, etc.), which in turn can make the bracket more appealing to some patients who may otherwise be reluctant to use dental brackets. In addition, the external surface of the bracket cover can be kept free of structural non-uniformities (as typically present on traditional braces), which in turn makes the bracket systems described herein easier to clean, less likely to be damaged, and more comfortable for the patient to wear.

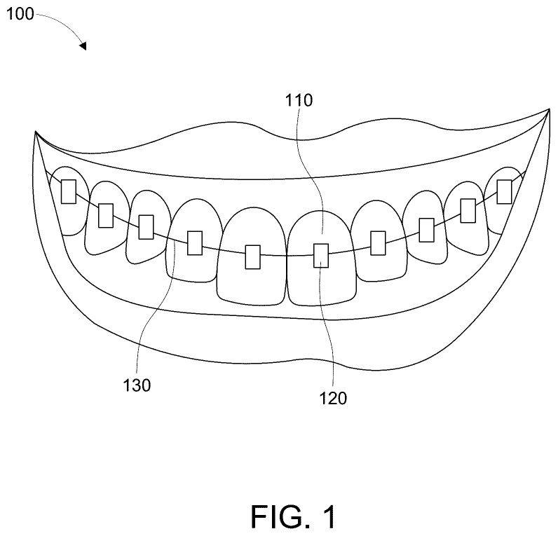

FIG. 1 shows a front view of a dental brace system 100 installed in the mouth of a patient. The dental brace system includes multiple dental brackets (e.g., dental bracket 120) attached to the patient's teeth (e.g., tooth 110). In some implementations, the dental bracket 120 is attached to an anterior surface of the tooth 110 by bonding material such as glue or a metal band. An arch wire 130 runs from dental bracket to dental bracket, connecting the dental brackets and applying pressure on the teeth. Depending on the configuration of the dental brackets, the pressure applied to the teeth by the wire 130 and any auxiliary items such as springs or rubber bands (not shown) provides a particular force profile that moves the teeth into their desired positions.

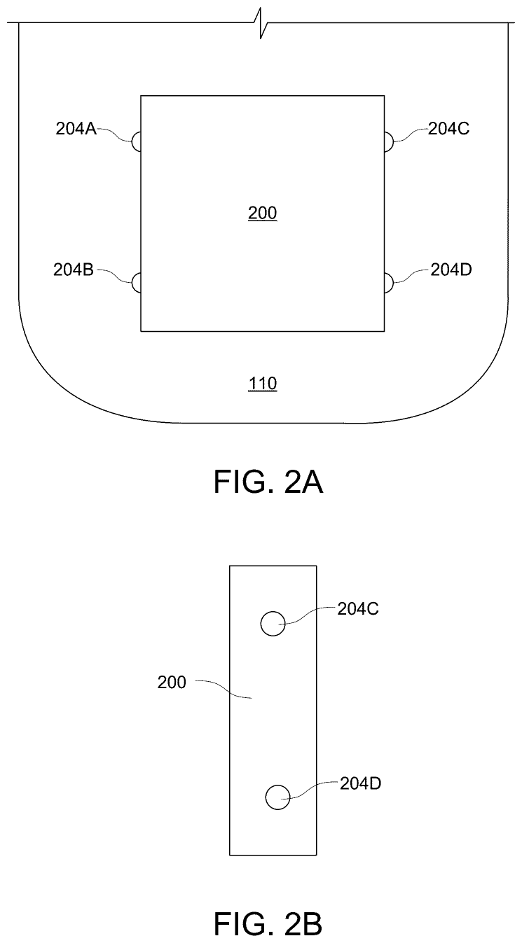

In some implementations, one or more dental brackets of the dental brace system 100 may have removable covers. For example, the dental bracket 120 may include a base and a removable cover. Referring to FIGS. 2A-2B, a base 200 of the dental bracket 120 may be attached to the anterior surface of tooth 110. FIG. 2A is a front view of the base 200 attached to the tooth 110, and FIG. 2B is a side view. The base 200 may be attached to the tooth by a bonding material such as glue or a metal band. In some implementations, the base 200 of the dental bracket 120 may be attached to the tooth 110 without needing to be removed or replaced throughout the entire course of orthodontic treatment.

The base 200 of the dental bracket 120 may further include a connection mechanism for connecting the base 200 to a cover 300 of the dental bracket 120. The connection mechanism can include connecting structures 204A-204D (herein referred to collectively as connecting structures 204). In the embodiment shown, the connecting structures 204 are four male structures disposed on the mesial and distal (i.e., side) aspects of the base 200. However, more or fewer connecting structures 204 may be included, and they may be disposed on different aspects of the base 200. In general, many connection mechanisms are well known in the art, and any connection mechanism suitable for connecting the base 200 to a cover 300 of the dental bracket 120 may be implemented. Some other non-limiting examples of connection mechanisms are further provided in relation to the embodiments further described herein.

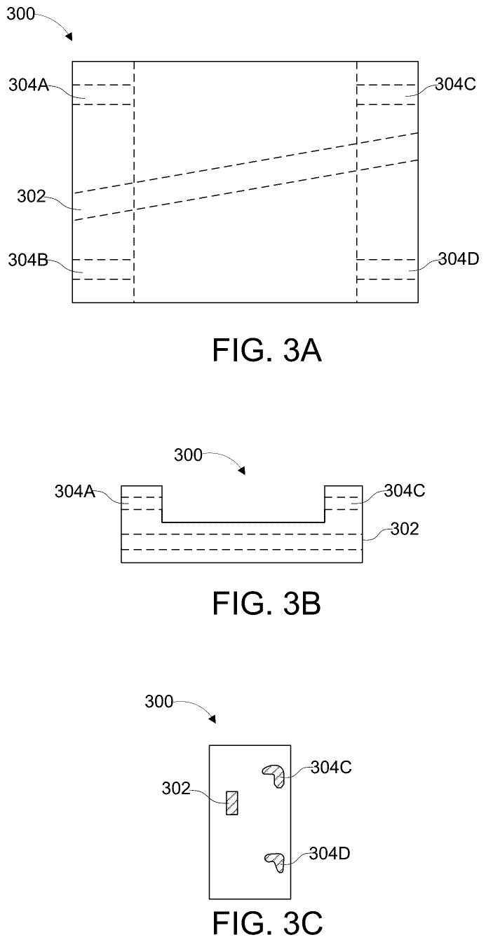

FIGS. 3A-3C show a cover 300 of the dental bracket 120. FIG. 3A is a front view of the cover 300, FIG. 3B is a top view of the cover 300, and FIG. 3C is a side view of the cover 300. The cover 300 is configured to be attached to the base 200 of the dental bracket 120. For example, the cover 300 can be shaped to receive the base 200 and can have connecting structures 304A-304D (herein referred to collectively as connecting structures 304) corresponding to the connecting structures 204 of the base 200. In the embodiment shown in FIGS. 3A-3C, the connecting structures 304 are female structures (e.g., grooves) configured to receive the corresponding male connecting structures 204 of the base 200. In some implementations, the grooves can be through-holes extending all the way through the outer side surfaces of the cover 300; in some implementations the grooves may extend only partially into the body of the cover 300. Once again, the configuration of the connecting structures 304 and the type of connection mechanism implemented are not limited to the particular embodiments described herein.

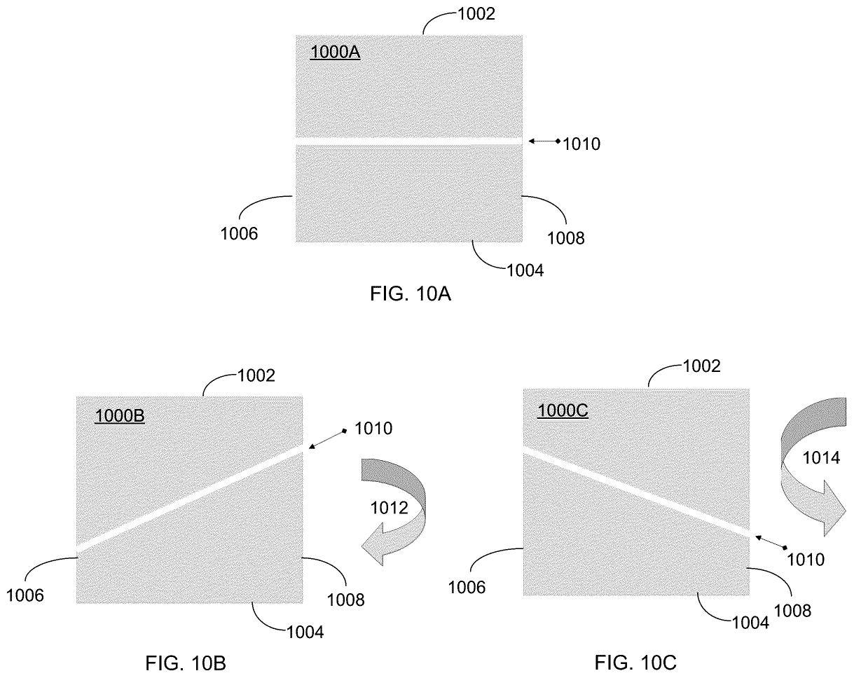

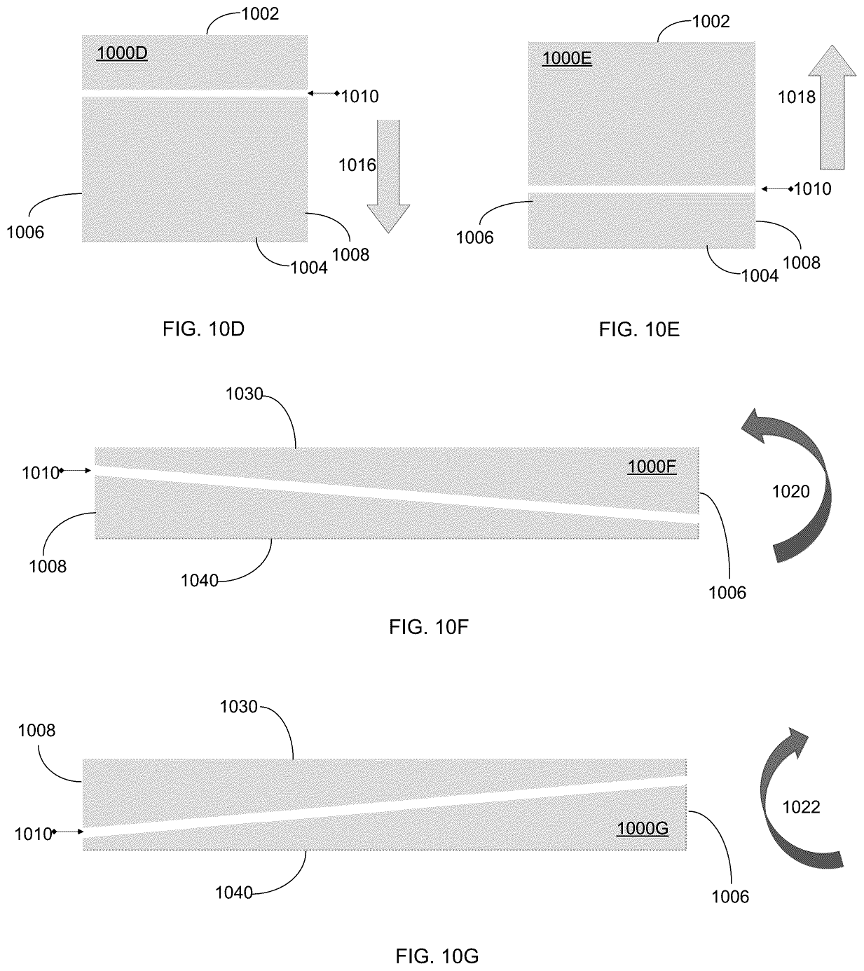

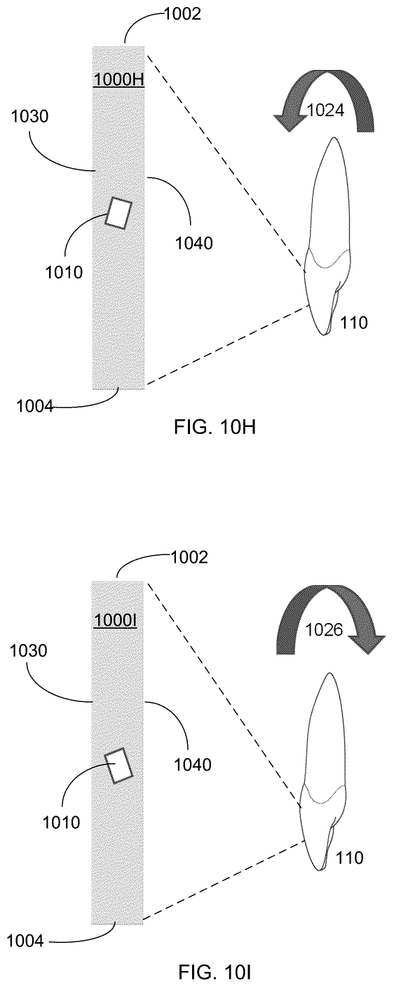

The cover 300 also has a slot 302 that extends from one side of the cover 300 (e.g., a mesial side) through the opposite side (e.g., a distal side). The slot 302 is configured to receive the wire 130, enabling the covers of multiple dental brackets to be connected. Compared to existing dental brace systems, the slot 302 may provide greater contact surface area between the bracket 120 and the wire 310, potentially reducing the time required to achieve certain tooth movements and thereby shortening overall treatment time. Different configurations and geometries of the slot 302 may correspond to different target tooth movements, and are described in further detail with respect to FIGS. 10A-10I.

In some implementations, the cover 300 can have a low-profile and smooth anterior surface. Compared to existing dental brackets, which typically include slots and notches, the cover 300 may be easier for a patient to clean; cause less irritation to the lips and inside cheek of the patient; and get caught on objects (e.g., food) less frequently, reducing the likelihood of damage to the dental brace system 100. In some implementations, the anterior surface of the cover 300 can include cosmetic elements, increasing the aesthetic appeal of the dental brace system 100. For example, the anterior surface of the cover 300 can include colors, designs, jewels, logos, symbols, etc. that may be customizable by the patient. Moreover, since the cover 300 of the dental bracket 120 is removable from the base 200, a clinician can easily replace the covers 300 over the course of treatment, in accordance with the patient's liking.

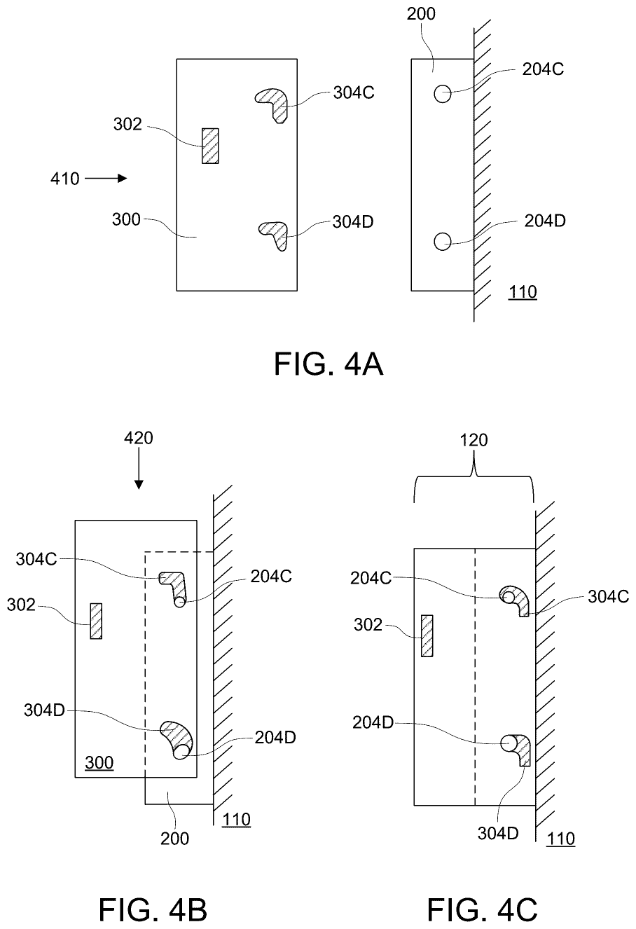

As discussed previously, the cover 300 of the dental bracket 120 may be attached and removed to the base 200 using various connection mechanisms. An example implementation of a connection mechanism is shown in FIGS. 4A-4C. Referring to FIG. 4A, the cover 300 and the base 200 of dental bracket 120 are shown in a separated state. By applying a substantially horizontal force 410 to the cover 300, the cover 300 can be connected to the base 200.

FIG. 4B shows the cover 300 and the base 200 in a connected state. In the connected state, the connecting structures 204 of the base 200 interface with the corresponding connecting structures 304 of the 300 to hold the cover 300 and the base 200 together. In some cases, the female connecting structures 304 may be configured to allow the cover 300 to move relative to the base 200 in the connected state. For example, in response to application of a downward force 420 on the cover 300 in the connected state shown in FIG. 4B, the cover 300 may move relative to the base 200.

In some implementations, the movement of the cover 300 in the connected state may enable the dental bracket 120 to achieve a locked state, in which the cover 300 is fixed relative to the base 200 until a threshold force is applied to “unlock” the cover 300 from the base 200. In some cases, the threshold force required to “unlock” the cover 300 from the base 200 in the locked state is substantially greater than the downward force 420 required to move the cover 300 relative to the base 200 in the connected state shown in FIG. 4B. For example, FIG. 4C shows the dental bracket 120 in a locked state. In this embodiment, the female connecting structures 304 are shaped (e.g., with variable width) such that a tighter interference fit is achieved in the locked state than in the connected state shown in FIG. 4B. In some implementations, the locked state can correspond to an alignment of the top and bottom surfaces of the cover 300 with the top and bottom surfaces of the base 200. While FIGS. 4A-4C depict connecting structures 204 as male structures and connecting structures 304 as female structures, in some implementations these may be switched or entirely different connecting structures may be used.

In some implementations, the two-step positioning of the cover 300 relative to the base 200 of the dental bracket 120 may allow for varying amounts of friction between the dental bracket 120 and the wire 130. For example, the connected state shown in FIG. 4B may correspond to a low friction setting that allows for a sliding movement of the wire 130 relative to the dental bracket 120. Meanwhile, the locked state shown in FIG. 4C may correspond to a high friction setting used for ligation positioning.

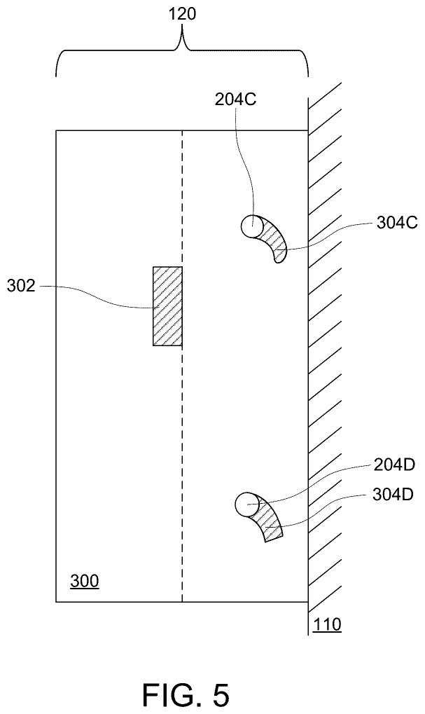

In some implementations, the slot 302 may not pass through the cover 300 such that it is longitudinally enclosed by the body of the cover 300. In some implementations, the slot may be 302 may be partially formed by the base 200, and is longitudinally enclosed only when the cover 300 is connected to the base 200. For example, FIG. 5 shows a second embodiment of the dental bracket 120 in a locked state. Compared to the embodiment of FIG. 4C, the slot 302 is partially formed by the anterior surface of the base 200. This embodiment may have the advantage of allowing the slot 302 to be positioned closer to the tooth 110, thereby allowing for a smaller dental bracket 120, which may be more comfortable for the patient.

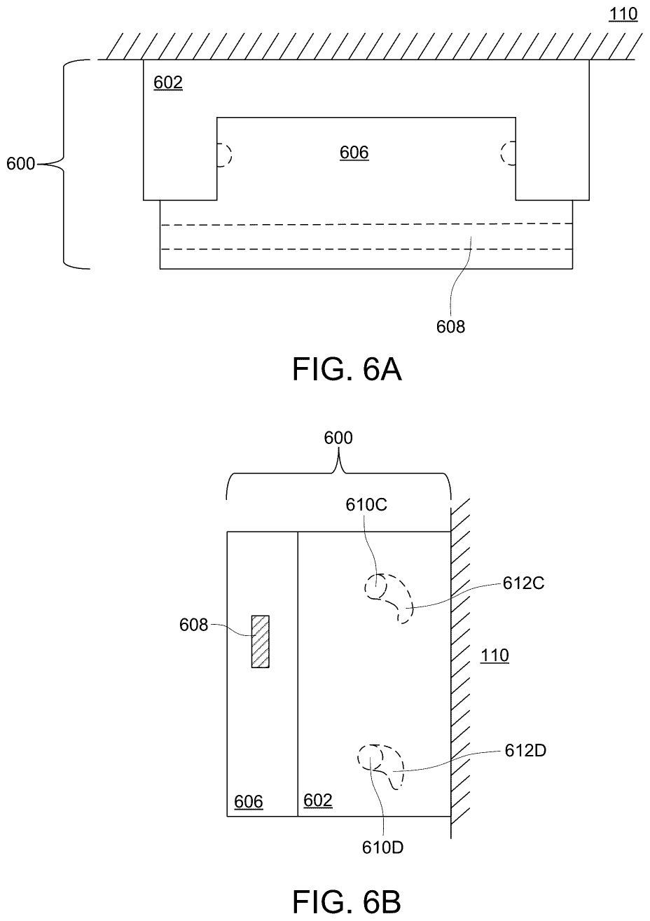

In some cases, different geometries of the base and cover may be implemented. FIGS. 6A-6B show a top view and side view, respectively, of a third embodiment of a dental bracket 600 in a locked state. Dental bracket 600 includes a base 602 attached to an anterior surface of the tooth 110 and a cover 606 removably connected to the base 602. In this embodiment, the base 602 is shaped to receive the cover 606. In particular, the base 602 includes male connecting structures 610C, 610D that are configured to interface with corresponding female connecting structures 612C, 612D of the cover 606. The cover 606 further includes a slot 608 for receiving an arch wire. Compared to the embodiment of the dental bracket 120 shown in FIGS. 4A-4C, the dental bracket 600 may have the advantage of not having its connection mechanism outwardly exposed when the cover 606 is connected to the base 602.

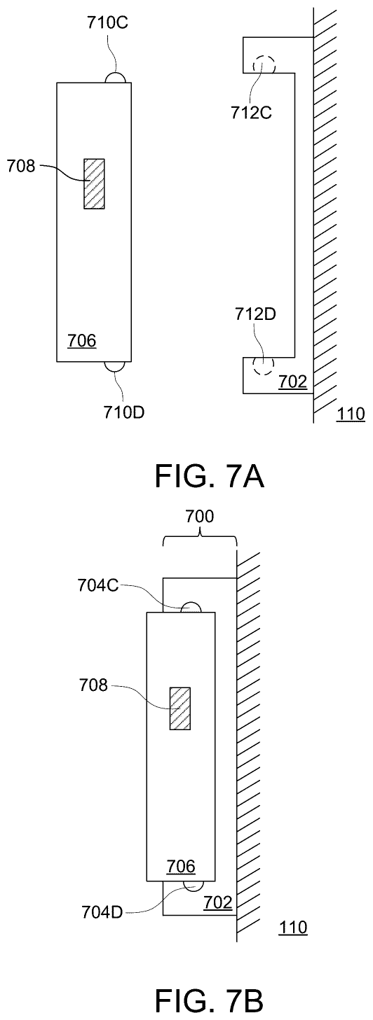

FIGS. 7A-7B show a fourth embodiment of a dental bracket 700 in a separated state and locked state respectively. In this implementation, the connecting mechanism of the dental bracket 700 is disposed on an upper and lower portion of the dental bracket 700 rather than on the sides. In particular, the dental bracket 700 includes a base 702 attached to an anterior surface of the tooth 110 and a cover 706 removably connected to the base 702. The base 702 includes female connecting structures 712C, 712D on the upper and lower portions of the base, the female connecting structures 712C, 712D configured to interface with corresponding male connecting structures 710C, 710D of the cover 706. In this embodiment, the connecting structures 710C, 710D are disposed on a top surface and a bottom surface respectively of the cover 706. The cover 706 further includes a slot 708 for receiving an arch wire. Compared to the embodiment of the dental bracket 120 shown in FIGS. 4A-4C, the dental bracket 700 may have the advantage of allowing for the slot 708 to be positioned closer to the tooth 110, thereby allowing for a smaller dental bracket 700.

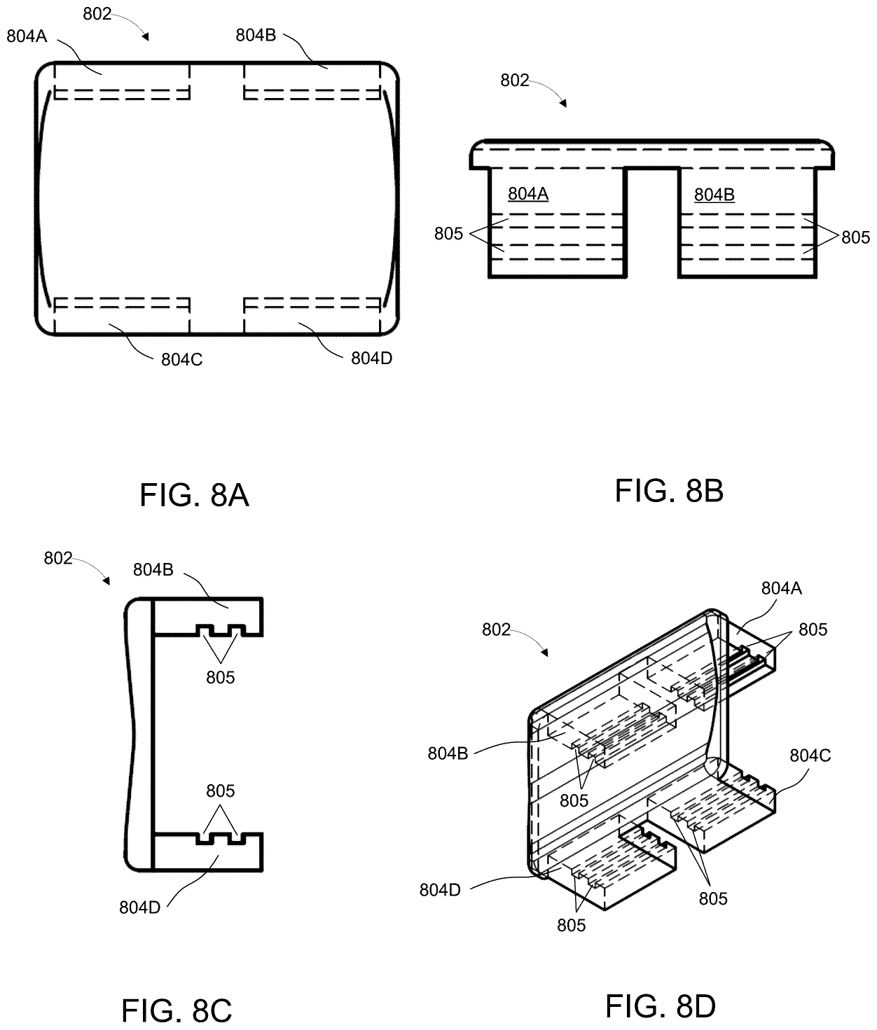

FIGS. 8A-8D show a base 802 of a fifth embodiment of a dental bracket. FIG. 8A is a posterior view of the base 802, FIG. 8B is a top view of the base 802, FIG. 8C is a side view of the base 802, and FIG. 8D is an isometric view of the base 802. As described in other embodiments, the anterior surface of the base (e.g., bases 200, 602, 702) may be attached to a tooth by a bonding material such as glue or a metal band. In some implementations, the base 802 may be attached to the tooth (e.g., tooth 110) without needing to be removed or replaced throughout the entire course of orthodontic treatment.

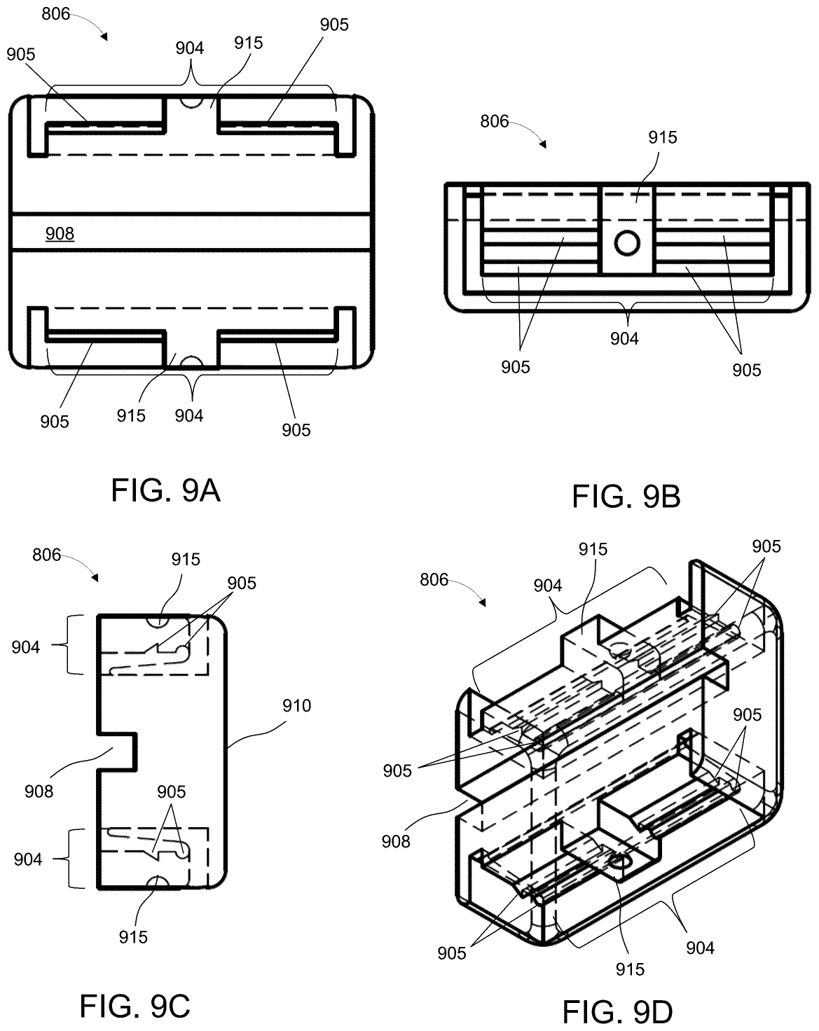

The base 802 includes a connection mechanism for connecting the base 802 to a cover 806 of the dental bracket (described in further detail with respect to FIGS. 9A-9D). The connection mechanism can include connecting structures 804A-804D (herein referred to collectively as connecting structures 804). In the embodiment shown, the connecting structures 804 protrude substantially orthogonally from a posterior surface of the base 802. In some cases, more or fewer connecting structures 804 may be included, and they may be disposed on different aspects of the base 802. Each of the connecting structures 804 include grooves 805, which are mating structures that allow the connecting structures 804 to mate with corresponding mating structures of the cover 806 (e.g. protrusions 905), described in further detail herein. While each of the connecting structures 804 is depicted as including two grooves 805, more or fewer grooves of various shapes may be included in other embodiments.

FIGS. 9A-9D show a cover 806 of a fifth embodiment of a dental bracket. FIG. 9A is an anterior view of the cover 806, FIG. 9B is a top view of the cover 806, FIG. 9C is a side view of the cover 806, and FIG. 9D is an isometric view of the cover 806. Similar to previously described embodiments, the cover 806 can have a low-profile and smooth anterior surface 910. The cover 806 can also be configured to be attached to the base 802 to form a dental bracket. For example, the cover 806 can include connecting structures 904 corresponding to the connecting structures 804 of the base 802. In the embodiment shown in FIGS. 9A-9D, each of the connecting structures 904 includes a protuberance 915 and protrusions 905. The protuberances 915 are configured to be received within spaces formed by the connecting structures 804 of the base 802 (e.g., the space between connecting structures 804A and 804B, and the space between connecting structures 804C and 804D). The protrusions 905 are mating structures that allow the connecting structures 904 to mate with corresponding mating structures of the base 802 (e.g. the grooves 805), for example, by an interference fit. In some cases, engagement of the protrusions 905 with the grooves 805 can serve to lock the cover 806 into place relative to the base 802, thereby increasing the force required to displace the cover 806 relative to the base 802. As best seen in FIG. 9C, the protrusions 905 may have various cross-sectional shapes (e.g., triangular, arcuate, etc.). Furthermore, while each of the connecting structures 904 is depicted in FIGS. 9A-9D as including two protrusions 905 (i.e., corresponding to the two grooves 805), more or fewer protrusions may be included in other embodiments.

The cover 806 further includes a slot 908 that extends from one side of the cover 806 (e.g., a mesial side) through the opposite side (e.g., a distal side). The slot 908 is configured to receive a wire (e.g. wire 130), enabling the covers of multiple dental brackets to be connected. Similar to the embodiment shown in FIG. 5, the slot 908 is configured to be partially formed by the anterior surface of the base 802 such that the slot 908 is fully enclosed when the cover 806 and the base 802 are connected. This embodiment may have the advantage of allowing the slot 908 to be positioned closer to the tooth (e.g., tooth 110), thereby allowing for a smaller dental bracket, which may be more comfortable for the patient.

In any of the embodiments described herein, different dental bracket covers can be configured to generate different force profiles corresponding to target teeth movements. FIGS. 10A-10I show examples of such covers 1000A-1000I (collectively referred to as covers 1000). Each of the covers 1000 has an incisal (top) aspect 1002, a gingival (bottom) aspect 1004, a mesial aspect 1006, a distal aspect 1008, an anterior (front) aspect 1030, and a posterior (back) aspect 1040. Each of the covers 1000 further includes a slot 1010 that is configured differently in each cover to generate various force profiles.

FIG. 10A shows a front view of a cover 1000A with a slot 1010 that runs horizontally through the cover 1000A and is positioned equidistant from the incisal aspect 1002 and gingival aspect 1004 of the cover 1000A. This cover may be used to generate a neutral force profile, for example, when a tooth is already properly positioned and no further movement is desired.

FIG. 10B shows a front view of a cover 1000B with a slot 1010 that runs diagonally through the cover 1000B. In particular, the opening of the slot 1010 on the mesial aspect 1006 of the cover 1000A is lower than the opening on the distal aspect 1008 of the cover 1000B. This cover may be used to generate a force profile corresponding to a mesial root movement or distal crown movement indicated by motion arrow 1012.

FIG. 10C shows a front view of a cover 1000C with a slot 1010 that runs diagonally through the cover 1000C. In particular, the opening of the slot 1010 on the mesial aspect 1006 of the cover 1000A is higher than the opening on the distal aspect 1008 of the cover 1000C. This cover may be used to generate a force profile corresponding to a distal root movement or mesial crown movement indicated by motion arrow 1014.

FIG. 10D shows a front view of a cover 1000D with a slot 1010 that runs horizontally through the cover 1000D and is positioned closer to the incisal aspect 1002 than the gingival aspect 1004 of the cover 1000D. This cover may be used to generate a force profile corresponding to an intrusion movement, or downward tooth movement, indicated by motion arrow 1016.

FIG. 10E shows a front view of a cover 1000E with a slot 1010 that runs horizontally through the cover 1000E and is positioned closer to the gingival aspect 1004 than the incisal aspect 1002 of the cover 1000E. This cover may be used to generate a force profile corresponding to an extrusion movement, or upward tooth movement, indicated by motion arrow 1018.

FIG. 10F shows a top view of a cover 1000F with a slot 1010 that runs diagonally through the cover 1000F. In particular, the opening of the slot 1010 on the distal aspect 1008 of the cover 1000F is closer to the anterior aspect 1030 than the posterior aspect 1040 of the cover 1000F. Meanwhile, the opening of the slot 1010 on the mesial aspect 1006 of the cover 1000F is closer to the posterior aspect 1040 than the anterior aspect 1030 of the cover 1000F. This cover may be used to generate a force profile corresponding to a mesial rotation of a tooth indicated by motion arrow 1020.

FIG. 10G shows a top view of a cover 1000G with a slot 1010 that runs diagonally through the cover 1000G. In particular, the opening of the slot 1010 on the mesial aspect 1006 of the cover 1000F is closer to the anterior aspect 1030 than the posterior aspect 1040 of the cover 1000G. Meanwhile, the opening of the slot 1010 on the distal aspect 1008 of the cover 1000G is closer to the posterior aspect 1040 than the anterior aspect 1030 of the cover 1000G. This cover may be used to generate a force profile corresponding to a distal rotation of a tooth indicated by motion arrow 1022.

FIG. 10H shows a side view of a cover 1000H with a slot 1010 in which the walls of the slot 1010 are not parallel to the anterior aspect 1030, posterior aspect 1040, incisal aspect 1002, or gingival aspect 1004 of the cover 1000H. Instead, the slot 1010 is offset at an angle such that an upper portion of the slot 1010 is positioned closer to the posterior aspect 1040 of the cover 1000H than the lower portion of the slot 1010. This cover may be used to generate a buccal root torque on the tooth 110 corresponding to a buccal root movement indicated by motion arrow 1024. In some implementations, the angle at which the slot 1010 is offset can correspond to the amount of buccal root torque generated on the tooth 110. In other embodiments, a cross-section of the slot 1010 can have various shapes (e.g., other than rectangular). For example, in some cases, a first portion of the walls of the slot 1010 (e.g., one, two, or three walls of the slot 1010) can be parallel to the anterior aspect 1030, posterior aspect 1040, incisal aspect 1002, and/or gingival aspect 1004 of the cover 1000H, while the remaining walls of the slot 1010 are not parallel to the anterior aspect 1030, posterior aspect 1040, incisal aspect 1002, and/or gingival aspect 1004 of the cover 1000H.

FIG. 10I shows a side view of a cover 1000I with a slot 1010 in which the walls of the slot 1010 are not parallel to the anterior aspect 1030, posterior aspect 1040, incisal aspect 1002, or gingival aspect 1004 of the cover 1000I. Instead, the slot 1010 is offset at an angle such that an upper portion of the slot 1010 is positioned closer to the anterior aspect 1030 of the cover 1000I than the lower portion of the slot 1010. This cover may be used to generate a lingual root torque on the tooth 110 corresponding to a lingual root movement indicated by motion arrow 1026. In some implementations, the angle at which the slot 1010 is offset can correspond to the amount of buccal root torque generated on the tooth 110. In other embodiments, a cross-section of the slot 1010 can have various shapes (e.g., other than rectangular). For example, in some cases, a first portion of the walls of the slot 1010 (e.g., one, two, or three walls of the slot 1010) can be parallel to the anterior aspect 1030, posterior aspect 1040, incisal aspect 1002, and/or gingival aspect 1004 of the cover 1000H, while the remaining walls of the slot 1010 are not parallel to the anterior aspect 1030, posterior aspect 1040, incisal aspect 1002, and/or gingival aspect 1004 of the cover 1000H.

The covers 1000 described herein are not intended to be limiting, and a variety of additional configurations can be implemented. For example, the slot 1010 may be configured to have the combined properties of multiple of the example covers described (e.g., to generate both a force profile corresponding to both a buccal root movement and intrusion movement).

In some cases, using a combination of the covers described above can obviate the need for auxiliary components such as springs or elastics to accomplish particular tooth movements. However, in other cases, the covers described above can be used in combination with auxiliary components for faster treatment time.

In some implementations, the various covers 1000 may be interchangeable (e.g., by having the same size, shape, connecting structures, etc.). For example, the bases of the dental brackets may be fixed to the patient's teeth for the entire duration of treatment, while the covers can be easily removed and replaced. In some cases, interchanging the covers 1000 may allow for fixing damaged dental brackets, replacing an arch wire, adjusting the force profile applied to the patient's teeth, changing the aesthetics of the dental brace system, etc. In some cases, using dental brackets with interchangeable covers can have the advantage of being easier to operate for clinicians, saving time and money for both the clinician and patient.

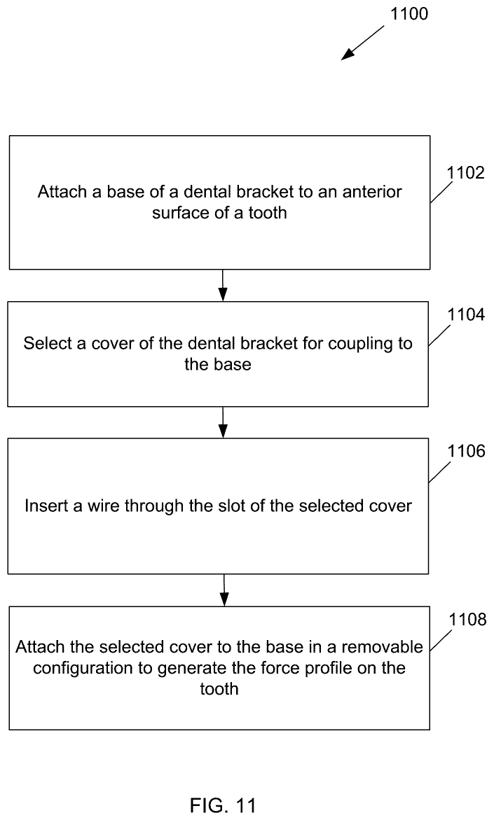

FIG. 11 shows a flow chart of a process 1100 for generating a force profile corresponding to a target tooth movement. In some implementations, the operations of the process 1100 can be performed by a person of relevant expertise such as an orthodontist, a dentist, a technician, an assistant, etc.

Operations of the process 1100 include attaching a base of a dental bracket to an anterior surface of a tooth (1102). In some implementations, the base of the dental bracket may correspond to the base 200 of the dental bracket 120, the base 602 of the dental bracket 600, or the base 702 of the dental bracket 700.

Operations of the process 1100 further include selecting a cover of the dental bracket for coupling to the base (1104). The cover is selected in accordance with the force profile corresponding to the target tooth movement. The cover can be selected from multiple candidate covers, each of which comprises a slot configured to receive a wire. In some implementations, at least one of the size, shape, or orientation of the slot corresponds to the force profile corresponding to the target tooth movement. The target tooth movements may include a mesial root movement, a distal root movement, a mesial crown movement, a distal crown movement, an intrusion movement, an extrusion movement, a mesial crown rotation, a distal crown rotation, a buccal root movement, or a lingual root movement. Examples of candidate covers are described above in relation to FIGS. 10A-10I. In some implementations, the slot is longitudinally enclosed within the cover and comprises a first cross-section opening on a mesial aspect of the cover and a second cross-section opening on a distal aspect of the cover. In some implementations, the slot comprises a first cross-section opening on a mesial aspect of the cover, a second cross-section opening on a distal aspect of the cover, and a longitudinal opening on a posterior aspect of the cover. In some implementations, the slot is configured to be longitudinally enclosed upon connecting the cover of the dental bracket to the anterior surface of the base.

Operations of the process 1100 further include inserting a wire through the slot of the selected cover (1106) and attaching the selected cover to the base in a removable configuration to generate the force profile on the tooth (1108). In some implementations, attaching the selected cover of the dental bracket to the anterior surface of the base can include coupling one or more of a first mating structure of the base with corresponding one or more second mating structures of the cover. For example, the one or more of a first mating structure may correspond to connecting structures 204 while the corresponding one or more second mating structures may correspond to the connecting structures 304.

In some implementations, operations of the process 1100 can further include locking the wire into position relative to the dental bracket such that the wire has a singular degree of freedom comprising sliding through the slot. Locking the wire into position relative to the dental bracket may include applying force to the cover in a first direction, the first direction being different from a direction of force required to connect the cover of the dental bracket to the base. For example, locking the wire into position relative to the dental bracket may correspond to the “locked” state described above in relation to FIG. 4C.

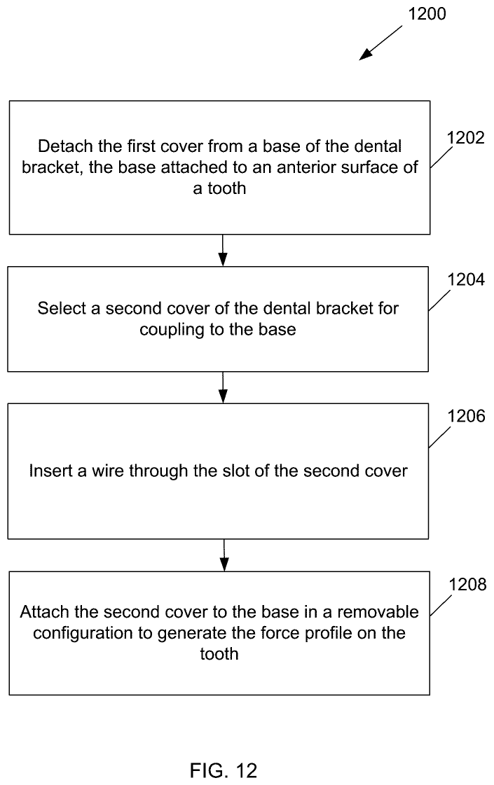

FIG. 12 shows a flow chart of a process 1200 for changing a first cover of a dental bracket. In some implementations, the operations of the process 1200 can be performed by a person of relevant expertise such as an orthodontist, a dentist, a technician, an assistant, etc.

Operations of the process 1200 include detaching the first cover from a base of the dental bracket, the base attached to an anterior surface of a tooth (1202). In some implementations, the base of the dental bracket may correspond to the base 200 of the dental bracket 120, the base 602 of the dental bracket 600, the base 702 of the dental bracket 700, or the base 802.

Operations of the process 1200 further include selecting a second cover of the dental bracket for coupling to the base (1204). The second cover can be selected from multiple candidate covers, each of which comprises a slot configured to receive a wire, the orientation of the slot being in accordance with a force profile corresponding to a target tooth movement. In some implementations, at least one of the size, shape, or orientation of the slot corresponds to the force profile corresponding to the target tooth movement. The target tooth movements may include a mesial root movement, a distal root movement, a mesial crown movement, a distal crown movement, an intrusion movement, an extrusion movement, a mesial crown rotation, a distal crown rotation, a buccal root movement, or a lingual root movement. Examples of candidate covers are described above in relation to FIGS. 10A-10I. In some implementations, the slot is longitudinally enclosed within the second cover and comprises a first cross-section opening on a mesial aspect of the second cover and a second cross-section opening on a distal aspect of the second cover. In some implementations, the slot comprises a first cross-section opening on a mesial aspect of the second cover, a second cross-section opening on a distal aspect of the second cover, and a longitudinal opening on a posterior aspect of the second cover. In some implementations, the slot is configured to be longitudinally enclosed upon connecting the second cover of the dental bracket to the anterior surface of the base. In some implementations, the second cover has a modified slot that differs in size, shape, or orientation, from a slot of the first cover. In some implementations, the second cover includes one or more cosmetic elements on its anterior surface that differ from one or more cosmetic elements on the anterior surface of the first cover.

Operations of the process 1200 further include inserting a wire through the slot of the second cover (1206) and attaching the second cover to the base in a removable configuration to generate the force profile on the tooth (1208). In some implementations, detaching the first cover of the dental bracket from the anterior surface of the base can include decoupling one or more of a first mating structure of the base with corresponding one or more second mating structures of the first cover. In some implementations, attaching the second cover of the dental bracket to the anterior surface of the base can include coupling one or more of a first mating structure of the base with corresponding one or more second mating structures of the second cover. For example, the one or more of a first mating structure may correspond to connecting structures 204 while the corresponding one or more second mating structures may correspond to the connecting structures 304.

In some implementations, operations of the process 1200 can further include locking the wire into position relative to the dental bracket such that the wire has a singular degree of freedom comprising sliding through the slot. Locking the wire into position relative to the dental bracket may include applying force to the second cover in a first direction, the first direction being different from a direction of force required to connect the second cover of the dental bracket to the base. For example, locking the wire into position relative to the dental bracket may correspond to the “locked” state described above in relation to FIG. 4C.

In some implementations, operations of the process 1200 can further include, prior to inserting the wire through the slot of the second cover, removing the wire from a slot of the first cover. In some implementations, the wire inserted through the slot of the second cover can be a replacement wire distinct from a wire extending through a slot of the first cover.

A number of embodiments have been described. Nevertheless, it will be understood that various modifications can be made without departing from the spirit and scope of the apparatus, systems, and techniques described herein. In addition, other components can be added to, or removed from, the described apparatus and systems. Accordingly, other embodiments are within the scope of the following claims.

1-42. (canceled)

43. A dental bracket comprising:
a base configured to be attached to an anterior surface of a tooth, wherein the base comprises four connecting structures that protrude substantially orthogonally from a posterior surface of the base, and wherein each of the four connecting structures comprises one or more grooves; and
a cover that is removably attached to the base, wherein the cover comprises (i) a slot configured to receive a wire and (ii) one or more protrusions configured to mate with the one or more grooves of the base when the cover is attached to the base.

44. The dental bracket of claim 43, wherein a first connecting structure and a second connecting structure of the four connecting structures are disposed along a top portion of the base, and wherein a third connecting structure and a fourth connecting structure of the four connecting structures are disposed along a bottom portion of the base.

45. The dental bracket of claim 44, wherein the cover comprises a first protuberance configured to be received by a space formed between the first connecting structure and the second connection structure, and wherein the cover comprises a second protuberance configured to be received by a space formed between the third connecting structure and the fourth connecting structure.

46. The dental bracket of claim 43, wherein the one or more grooves of the base comprise two parallel grooves with matching cross-sectional shapes.

47. The dental bracket of claim 43, wherein the one or more protrusions configured to mate with the one or more grooves have different cross-sectional shapes.

48. The dental bracket of claim 43, wherein the one or more protrusions configured to mate with the one or more grooves comprise (i) a first protrusion having a triangular cross-sectional shape and (ii) a second protrusion having an arcuate cross-sectional shape.

49. The dental bracket of claim 48, wherein the second protrusion having the arcuate cross-sectional shape is disposed anterior of the first protrusion having the triangular cross-sectional shape.

50. The dental bracket of claim 43, wherein at least one of a size, shape, or orientation of the slot corresponds to a force profile corresponding to a target tooth movement.

51. The dental bracket of claim 50, wherein the target tooth movement comprises a mesial root movement, a distal root movement, a mesial crown movement, a distal crown movement, an intrusion movement, an extrusion movement, a mesial crown rotation, a distal crown rotation, a buccal root movement, or a lingual root movement.

52. The dental bracket of claim 43, wherein the slot comprises a first cross-section opening on a mesial aspect of the cover, a second cross-section opening on a distal aspect of the cover, and a longitudinal opening on a posterior aspect of the cover.

53. The dental bracket of claim 52, wherein the slot is configured to be longitudinally enclosed upon connecting the cover of the dental bracket to the anterior surface of the base.

54. The dental bracket of claim 43, wherein the cover comprises one or more cosmetic elements on its anterior surface.

55. The dental bracket of claim 54, wherein the one or more cosmetic elements comprise at least one of a color, a design, a jewel, a logo, or a symbol.

56. A dental brace system comprising:
one or more dental brackets, each dental bracket comprising:
a base configured to be attached to an anterior surface of a tooth, wherein the base comprises four connecting structures that protrude substantially orthogonally from a posterior surface of the base, and wherein each of the four connecting structures comprises one or more grooves; and
a cover that is removably attached to the base, wherein the cover comprises (i) a slot configured to receive a wire and (ii) one or more protrusions configured to mate with the one or more grooves of the base when the cover is attached to the base; and
a wire extending through the slot of each dental bracket.

57. The dental brace system of claim 56, wherein a first connecting structure and a second connecting structure of the four connecting structures are disposed along a top portion of the base, and wherein a third connecting structure and a fourth connecting structure of the four connecting structures are disposed along a bottom portion of the base.

58. The dental brace system of claim 57, wherein the cover comprises a first protuberance configured to be received by a space formed between the first connecting structure and the second connection structure, and wherein the cover comprises a second protuberance configured to be received by a space formed between the third connecting structure and the fourth connecting structure.

59. The dental brace system of claim 56, wherein the one or more grooves of the base comprise two parallel grooves with matching cross-sectional shapes.

60. The dental brace system of claim 56, wherein the one or more protrusions configured to mate with the one or more grooves have different cross-sectional shapes.

61. The dental brace system of claim 56, wherein at least one of a size, shape, or orientation of the slot corresponds to a force profile corresponding to a target tooth movement.

62. The dental brace system of claim 56, wherein the slot comprises a first cross-section opening on a mesial aspect of the cover, a second cross-section opening on a distal aspect of the cover, and a longitudinal opening on a posterior aspect of the cover.
